(19) United States
(12) Patent Application Publication
(10) Pub. No.: US 2018/0056280 A1
(43) Pub. Date: Mar. 1, 2018

(54) Efficiency of Refinery FCCU Additives

(71) Applicant: Quanta Technologies, LLC, Houston, TX (US)

(72) Inventor: Augusto Quinones, Houston, TX (US)

(73) Assignee: Quanta Technologies, LLC, Houston, TX (US)

(21) Appl. No.: 15/684,570

(22) Filed: Aug. 23, 2017

Related U.S. Application Data
(60) Provisional application No. 62/378,540, filed on Aug. 23, 2016.

(51) Int. Cl. B01J 29/40; C10L 10/02; C10G 11/18; C10L 10/10; B01J 35/02

(52) U.S. Cl. CPC B01J 29/40; C10L 2270/023; C10G 11/18; C10L 10/10; B01J 35/023; C10G 2300/405; C10G 2300/207; C10G 2300/4043; C10G 2300/305; C10G 2300/205; C10G 2400/02; C10G 2300/80; C10L 2200/0423; C10L 2230/04; C10L 10/02

(57) ABSTRACT

This invention is an improvement to refinery Fluid Catalytic Cracking Unit (FCCU) additives. The improved is obtained through the adjustment of the particle size distributions of the additives. Narrowing the range of particle size distributions for the additives results in improved performance in a wide range of additive compounds. In addition it allows for removal of the additives when combined with cracking catalysts.

### TECHNICAL FIELD

The efficiency of refinery Fluid Catalytic Cracking Unit (FCCU) additives is improved through the adjustment of the particle size distributions of the additives. Narrowing the range of particle size distributions for the additives results in improved performance in a wide range of additive compounds.

### BACKGROUND OF THE INVENTION

FCCU additives are compounds that are introduced into the unit through blending with the FCCU catalyst, injection into the FCCU feed or other methods of addition to the FCCU operation. Additive compounds are used to enhance FCCU performance. The benefits of these additives include altering FCCU yields and reducing the amount of pollutants emitted from the regenerator. These additives are significantly different from the FCCU catalyst in that their basic function is not the catalytic cracking of the hydrocarbon molecules targeted by the catalyst but instead, a group of secondary reactions. The additives function quite differently from the FCCU catalysts; targeting molecules that are smaller than those impacted by FCCU catalysts, and promoting or creating chemical and physical reactions that are secondary and dissimilar to the primary catalytic reactions that occur in the FCCU. These secondary reactions do not modify molecules that existed in the original feed to the FCC unit, but involve reactions of products created from the primary cracking reactions. Secondary reactions include: gasoline cracking to LPG, SOx reduction to H2S, CO combustion in the regenerator, and passivation of metals deposited during primary cracking. In addition, the quantity of additive introduced into the FCCU system is less than 50% of the catalyst amount.

The present invention includes, but is not limited to, the following FCCU additives:

1. SO₂ reducing additive (SOx additive);
2. CO combustion promoter;
3. NOx reducing additive;
4. Shape-selective zeolite (e.g. ZSM-5) additive; other shape selective zeolites
5. Metal passivation additive;
6. Bottoms conversion additive.

SOx additive is an example of an FCCU additive included in the present invention. SOx additive, usually a metal oxide (as opposed to the silica alumina composition of the FCCU cracking catalyst), is added directly to the catalyst inventory. The additive works by absorbing and chemically bonding with SO₃ in the regenerator of the FCCU. This stable sulfate species is carried with the circulating catalyst to the riser, where it is reduced or “regenerated” by hydrogen or water to yield H2S and metal oxide. Thus, this reaction is completely different from the primary catalytic reaction in the FCCU.

Shape-selective zeolite is another example of an additive included in the present invention. Shape-selective zeolite has a different pore structure from that of the standard FCCU catalyst. The pore size of shape-selective zeolite is generally smaller than that of the typical FCCU catalyst. In addition, the pore arrangement of shape-selective zeolite is different from typical catalyst.

Shape-selective zeolite additive is added to the FCCU to boost gasoline octane and to increase light olefin yields. Shape-selective zeolite accomplishes this by upgrading low-octane components in the gasoline boiling range (C7 to C10) into light olefins (C3, C4, C5), as well as isomerizing low-octane linear olefins to high-octane branched olefins.

Metal passivation additives are also included in the present invention. These additives address nickel, vanadium, sodium and other metals present in the FCCU feedstock. These metals deposit on the catalyst, thus poisoning the catalyst active sites. These additives work through various chemical mechanisms, including forming non-reactive alloys with the target metals.

The above-described additives, as well as other additives used in the FCCU, all create and promote reactions in the FCCU that are significantly different from the primary cracking reactions in the Unit. The present invention increases the efficiency of these reactions through altering the particle size distribution of the additive by removing large particles from the additives.

The present invention improves the efficiency of an FCCU additive by creating one or more fractions of the additive through removal of one or more fractions above a threshold that is larger than the average particle size of the initial additive. As a non-limiting example, this threshold may be 90 microns. The newly created fraction, which has a smaller average particle size distribution, when introduced into the FCCU performs more efficiently than the initial additive.

The present invention also includes one or more fractions of an FCC additive created by removing most of the particles below a threshold and removing most of the particles above a threshold. These newly created fractions, which have a smaller average particle size distribution, when introduced into the FCCU perform more efficiently than the initial additive.

The present invention also includes a process for selective separation of the additive with a narrow particle size distribution from an FCC catalyst mixture where one fraction has a higher concentration of additive and the other has a lower concentration of additive.

### SUMMARY OF THE INVENTION

It has been discovered that the efficiency of secondary reactions of light molecules created or promoted by FCCU additives are dependent on the particle size of the additives. The present invention addresses this discovery by increasing the efficiency of the additive reactions through the creation and use of designed additive particle size distributions. These narrower designed particle size distributions can be obtained through sieving, screening, air classification or other separation methods.

One embodiment of the invention involves the removal of one or more fractions of the FCCU additive above a threshold that is larger than the average particle size of the initial additive. As non-limiting examples, this threshold could be 90 microns or 70 microns. This creates an additive with a smaller average particle size and a narrower particle size distribution that will more efficiently create or promote the secondary reactions associated with the additive.

Another embodiment of the invention includes the creation of one or more fractions of an FCCU additive by removing most of the particles below a threshold and removing most of the particles above a threshold. Without limitation these thresholds could include 20 microns, 70 microns and 120 microns. These fractions of FCCU additive will perform more efficiently in the FCCU.

A further embodiment of the present invention includes the creation of a fraction of a FCCU additive with a narrower particle size distribution; for purpose of example only with a particle size ranging from 20 microns to 70 microns, and the introduction of this fraction into the FCCU in a blend with the FCCU catalyst. After passing through the FCCU, the catalyst and additive fraction are removed and the additive is effectively taken out of the blend through screening or other separation method that separates the fraction containing the additive particle size distribution, in this example, the particles sized from 20-70 microns. This additive rich fraction can then be reused as can the fractions of the blend from which the additive has been removed.

Additional embodiments of the invention address the reprocessing of certain fractions of FCCU additive created as described above. The particles in fractions containing smaller particles (as a non-limiting example particles in a size range of up to 20 microns) can be reprocessed into larger particles through re-spray drying and reintroduced into the FCCU to promote or create more efficient reactions.

Fractions containing larger particles, for example in a particle size range of greater than 120 microns, can be reprocessed through grinding or other methods to reduce particle size and the reused. These reprocessed larger particles can also be re-spray dried and reused.

The present invention is also applicable to precursors to FCCU additives. The precursor components of FCCU additives can be divided into fractions with narrower particle size distributions as described above. Such fractions can include particles above a certain threshold and/or particles below a certain threshold. Fractions of additive precursors can also be reprocessed into smaller or larger particles, as is also described above.

### BRIEF DESCRIPTION OF THE DRAWINGS

FIG. 1 is a graph showing Sox Additive additions during the Heart-Cut phase.

FIG. 2 is a graph showing multivariable study of commercial operating conditions.

FIG. 3 is a graph showing an Example of Particle Size Distribution for a Typical Commercial FCC Spray Drier.

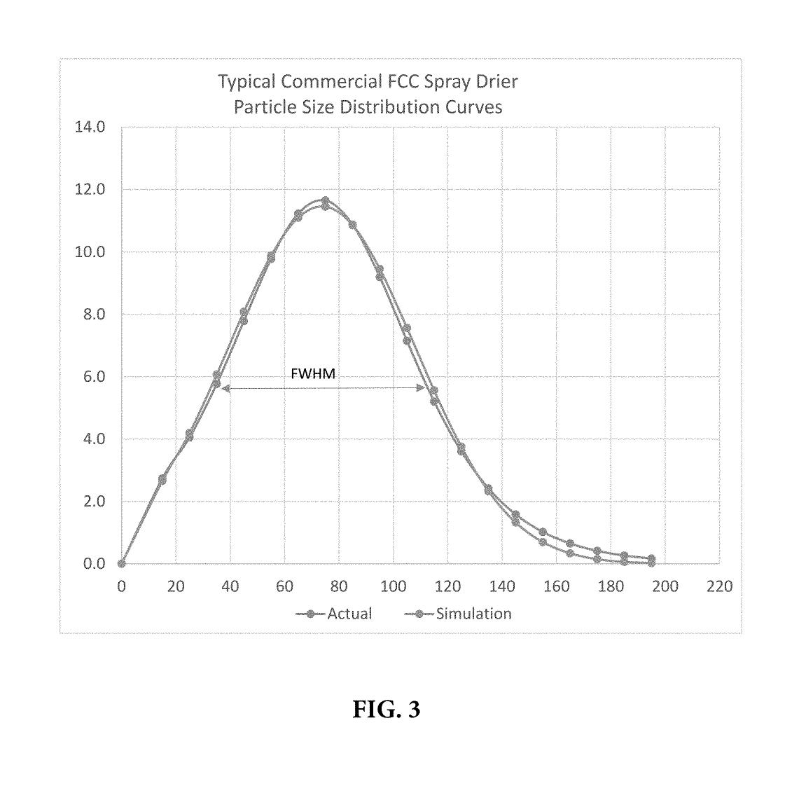

FIG. 4 is a graph showing a typical particle size distribution.

### DETAILED DESCRIPTION OF THE INVENTION

It has been discovered that FCCU additive reactions are subject to diffusion constraints which manifest themselves by their sensitivity to particle size Therefore, large particles of FCCU additives are detrimental to such reactions. The present invention involves the creation of not only additives that limit the presence of the large particles but also the creation of fractions of FCCU additives with substantial narrower particle size distributions. These fractions promote and create more efficient FCCU additive reactions. An non-limiting example of a fraction is some portion of particles that impacts performance.

They also provide a higher degree of optimization for each specific FCC unit and importantly, allow for the removal of the additive for other re-use of the base catalyst and the recovered additive.

One specific embodiment of the invention is related to the cracking of gasoline olefins with a shape selective zeolite (a high SiO₂/Al₂O₃ zeolite structure with that limits the size of the molecules that enter its 3-dimensional pore structure) such as ZSM-5, MCM-49, or MCM-56, Beta. Smaller particles have shown a higher efficiency. Thus, removing the larger particles results in a better additive. The larger particles can be used in units that do not retain small particles or they can be reprocessed into small particles via milling and re-agglomeration.

Refinery economics can such that, if in one period LPG olefins have the highest margin, in another period of time Gasoline can become the most valuable product. Having an effective way to accelerate the removal of the shape selective, (e.g. ZSM-5) additive would yield a substantial improvement in economics versus the current state of the art that would rely on stopping additions of the additive and letting it purge out of the system. By creating very narrow distributions from a typical spray dried product, the present invention can maximize the effectiveness of the additive and the effectiveness of the separation.

This can also be used with CO combustion promoters. The amount and type of CO promoters vary from unit to unit, and having the option to remove them increases the flexibility to re-sell some of the Equilibrium catalysts.

A third embodiment of the invention relates to SOx reduction additives. SOx reduction additives are used to reduce SOx emissions from refineries and are many times mandated by government regulation. SOx additives are complex catalysts with Ceria, V2O5, and a magnesium aluminum spinel or hydrotalcite. Typical SOx reductions are from 75 to 95% of uncontrolled emissions and they can be achieved by using 3 to 15% of the additive. Although the mechanism for the enhancement is not clearly understood at this time we have found that removal of the small particles and large particles from a typical additive yield a dramatic improvement in the SOx reduction of a catalyst composition. Some of the benefit is due to reduced losses. It has been discovered, however, that the large particles of SOx additive are much less efficient than the smaller particles that can be retained by the unit.

Currently when additives are mixed with catalysts the particles size distributions are pretty similar or equivalent. Because that is the case it is difficult if not impossible to separate additives from catalyst. One way to address this is to provide a limited size distribution additive, which enables separation of the additive from the catalyst.

The following examples demonstrate three applications of the present invention. These examples are illustrative of the present invention, and the present invention is not limited in application to these examples.

### Example 1

Shape-Selective Zeolite

A sample of commercial FCC catalyst was separated into two different fractions using a mechanical screen. The particle size distribution of the additive, a shape-selective zeolite, sold commercially as “ZSM-5 additive”, had an average particle size of 65 and 118 microns for the small and large particle size respectively.

These additives were blended at an 8% level with a low metal, typical FCC catalyst from a VGO unit from the West Coast of the United States. The additive was not steamed to maximize its activity simulating a very high ZSM-5 activity maximum propylene operation.

The base case was tested as well as the two additives in an ACE unit with a typical VGO at 990° F. at a catalyst to oil ratio of 6.5.

The results are shown on TABLE 1 and clearly demonstrate the following:

The effect of ZSM-5 is clearly noted in both additives as determine by a dramatic reduction in Gasoline and consequent increase in LPG olefins and other gases. The small particle size additive showed a reduction of 16.5 Vol % gasoline versus 14.9 Vol % for the large particle size additive.

Propylene yield, the most important selectivity for this case showed an increase 8.6 Vol % for the small particle additive versus 7.6 Vol %.

Depending on specific economics relevant for units with alkylation, the uplift is $0.42 versus $0.17 per bbl for the small and large particle additive respectively. For units that sell the propylene as chemical feedstock, the value creations is substantially greater.

TABLE 1

| | | wt % | wt % | | vol % | vol % |
|---|---|---|---|---|---|---|
| | wt % | Small | Large | vol % | Small | Large |
| | BASE | Particle | Particle | BASE | Particle | Particle |
| Quanta ID | Ecat | Size | Size | Ecat | Size | Size |
| Rxt Start | 990 | 990 | 990 | | | |
| Temp, ° F. | | | | | | |
| Catalyst-to- | 6.50 | 6.50 | 6.50 | | | |
| Oil, wt/wt | | | | | | |
| Conv., wt % | 77.79 | 77.71 | 76.84 | | | |
| YIELDS, wt %: | | | | | | |
| Coke | 4.76 | 4.88 | 4.68 | | | |
| Dry Gas | 2.38 | 4.18 | 4.07 | | | |
| Hydrogen | 0.09 | 0.09 | 0.08 | | | |
| Hydrogen | 0.00 | 0.00 | 0.00 | | | |
| Sulfide | | | | | | |
| Methane | 0.88 | 0.86 | 0.82 | | | |
| Ethane | 0.57 | 0.65 | 0.63 | | | |
| Ethylene | 0.84 | 2.58 | 2.54 | | | |
| Propane | 1.63 | 2.86 | 2.73 | 2.91 | 5.11 | 4.88 |
| Propylene | 5.75 | 10.65 | 10.09 | 10.06 | 18.63 | 17.66 |
| n-Butane | 1.40 | 1.32 | 1.26 | 2.23 | 2.09 | 2.01 |
| Isobutane | 5.69 | 8.64 | 8.08 | 9.04 | 13.73 | 12.84 |
| C4 Olefins | 4.78 | 6.20 | 5.73 | 7.36 | 9.55 | 8.82 |
| 1-Butene | 1.90 | 2.02 | 1.86 | 2.93 | 3.11 | 2.86 |
| Isobutylene | 1.46 | 1.35 | 1.37 | 2.25 | 2.08 | 2.11 |
| c-2-Butene | 1.42 | 2.82 | 2.50 | 2.19 | 4.35 | 3.85 |
| t-2-Butene | 0.00 | 0.00 | 0.00 | 0.00 | 0.00 | 0.00 |
| Butadiene | 0.00 | 0.00 | 0.00 | 0.00 | 0.00 | 0.00 |
| Gasoline | 51.40 | 39.00 | 40.21 | 68.37 | 51.87 | 53.48 |
| LCO | 14.80 | 14.95 | 15.47 | 14.95 | 15.10 | 15.62 |
| Bottoms | 7.41 | 7.34 | 7.69 | 6.82 | 6.75 | 7.07 |
| TOTAL | 100.00 | 100.00 | 100.00 | 121.74 | 122.84 | 122.39 |

### Example 2

### SOx Reduction Additive

In this example of the present invention, a test was carried out in a working refinery FCCU using a typical SOx reduction additive.

As part of this trial, the fresh SOx additive used by the refinery was separated into three distinct fractions according to particle size. As shown in Table 2, there was a fine fraction (with particles smaller than 45μ, a “heart-cut” fraction (45μ to 90μ) and a coarse fraction (with particles larger than 90μ). This example focuses on comparing the performance of the base additive (without any treatment). vs. the “heart-cut” fraction resulting from the treatment.

TABLE 2

| | | Size | | | | |
|---|---|---|---|---|---|---|
| | Weight | APS, | Size Range (μm) | | | |
| Product | Lbs. | um | 0-20 | 20-40 | 40-90 | 90+ |
| Heart Cut | 9333 | 64 | 0.7 | 9 | 76 | 15 |
| Coarse | 7937 | 99 | 0 | 2 | 39 | 59 |
| Fines | 2540 | 30 | 17 | 64 | 19 | 0 |

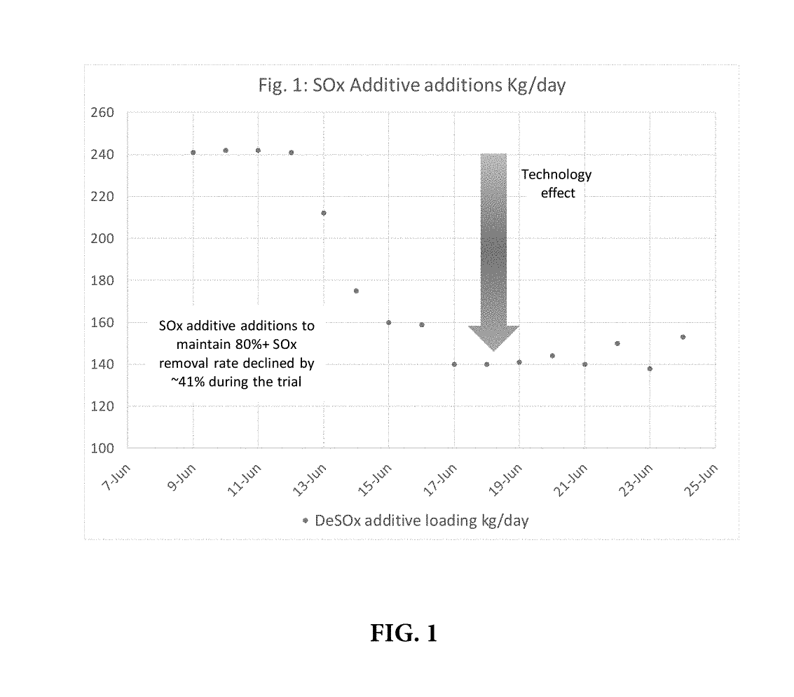

FIG. 1 shows the evolution of the SOx additive additions during the period when the heart-cut material was being added to the unit. As can be seen, the refinery was able to reduce additions from ˜240 to ˜140 Kg/day of additive to maintain a constant removal rate of ˜80%. This significant increase in additive efficiency occurred as the amount of treated material reached steady-state in the unit.

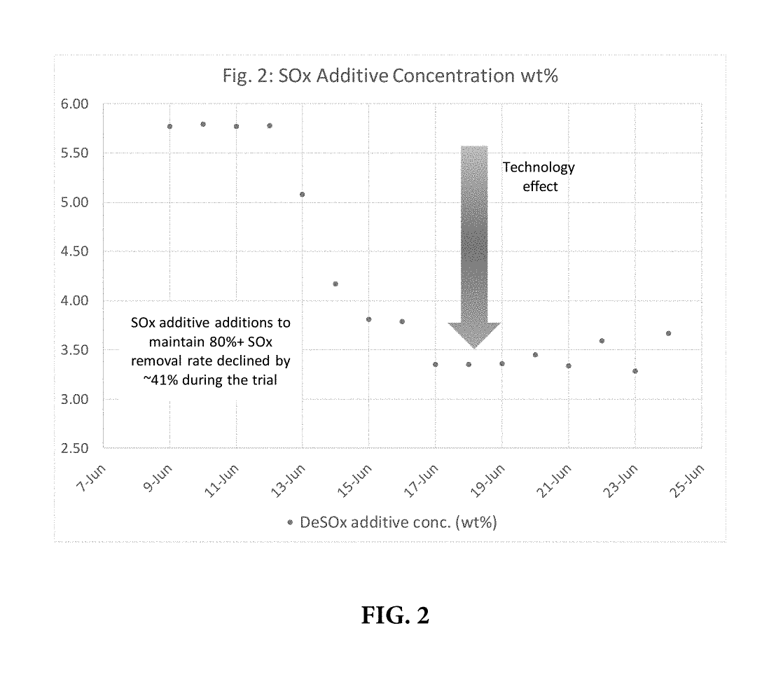

The two addition rates above in Kg/day are equivalent to concentrations of ˜5.8 wt % and 3.5 wt % of additive as a function of fresh catalyst additions, as shown in FIG. 2.

FIG. 2 shows a multivariable study of commercial operating conditions performed to confirm that operating variability did not account for the differences observed. It was concluded that the main variable causing the improved SOx reduction was the narrower particle size distribution created pursuant to the present invention.

### Example 3

Creation of Particle Size Distributions (ZSM-5 Additive)

This example of the present invention demonstrates how the creation of narrow particle size distribution additive fractions make the separation of the original host catalyst and the additive highly effective. This embodiment can be used to control the selectivity of the inventory of a unit by post-treatment of the working inventory without the need to wait for a very slow exchange of the composition of the inventory. Specifically, ZSM-5 additives are known to have a very long lifetime that can limit the profitability of the FCC unit.

In addition, the catalyst withdrawals from the working inventory of an FCC unit, the “Equilbrium Catalyst or ECAT,” can be traded so that it can be used by other refineries. In this ECAT trading market it is common to find ECAT's with too much or too little of some function. Having a way to control the concentration of additives via an enhanced separation due to the narrow PSD of the additive is not only novel but also highly desirable. The example below demonstrates how the present invention can be utilized to create various “cuts” of catalyst and additive with different levels of efficiency.

Base Materials:

An FCC Equilibrium catalyst from a US Gulf Coast was used as the host catalyst.

A commercially available FCC ZSM-5 additive was added to the Ecat to create the different blends.

The chemical composition and the particle size of the Ecat and the ZSM-5 additive are included in TABLE 3

TABLE 3

| | | Base Ecat | Additive |
|---|---|---|---|
| Na (%) | | 0.20 | 0.24 |
| Ni (%) | | 0.08 | 0.01 |
| V (%) | | 0.12 | 0.01 |
| P2O5 (%) | | 0.54 | 11.50 |
| P2O5(5)* | | 0.00 | 11.50 |
| Al2O3 (%) | | 38.25 | 26.34 |
| Fe2O3 (%) | | 0.87 | 0.64 |
| MgO (%) | | 1.87 | 0.00 |
| TiO2 (%) | | 1.54 | 0.74 |
| SiO2 (%) | | 53.14 | 62.50 |
| CeO2 (%) | | 0.26 | 0.00 |
| La2O3 (%) | | 2.10 | 0.14 |
| APS, microns | | 68 | 76 |
| 0-40 micron | % | 3 | 14 |

Catalyst A:

950 grams of the host Ecat were blended with 50 grams of the commercially available ZSM-5 additive.

Catalyst B:

The commercially available ZSM-5 additive was sieved with a 165 mesh screen to remove all the particles that could not pass through the screen.

The material that went through the 165 mesh screen was further screened with a 200 mesh screen to remove all particles smaller than the holes defined by the 200 mesh screen size.

Catalyst B was made by mixing 50 grams of the narrow fraction of the screened additive, smaller than the holes of the 165 mesh screen but larger than the holes of the 200 mesh screen was blended with 950 grams of the host Ecat.

Catalyst C:

The commercially available ZSM-5 additive was sieved with a 250 mesh screen to remove all the particles that could not pass through the screen.

The material that went through the 250 mesh screen was further screened with a 325 mesh screen to remove all particles smaller than the holes defined by the 325 mesh screen size.

Catalyst C was made by mixing 50 grams of the narrow fraction of the additive, smaller than the holes of the 250 mesh screen but larger than the holes of the 325 mesh screen with 950 grams of the host Ecat.

The properties of Catalysts A, B and C are shown in Table 4.

TABLE 4

| | CATALYST | CATALYST | CATALYST |
|---|---|---|---|
| | A | B | C |
| Na (%) | 0.21 | 0.23 | 0.21 |
| Ni (%) | 0.09 | 0.08 | 0.08 |
| V (%) | 0.12 | 0.13 | 0.12 |
| P2O5 (%) | 1.06 | 1.15 | 1.04 |
| P2O5(5)* | 0.52 | 0.61 | 0.50 |
| AL2O3(%) | 38.34 | 43.25 | 38.50 |
| Fe2O3 (%) | 0.88 | 0.94 | 0.88 |
| MgO (%) | 1.81 | 2.18 | 1.92 |
| (%) | 1.53 | 1.69 | 1.54 |
| SiO2 (%) | 54.48 | 60.92 | 54.73 |
| CeO2 (%) | 0.26 | 0.30 | 0.27 |
| La2O3 (%) | 2.03 | 2.23 | 2.03 |

Catalyst AA:

Catalyst A was screened with a 165 mesh screen and a 200 mesh screen similarly to CATALYST B.

The catalyst A was re-screened with a 165 mesh screen and a 200 mesh screen to yield fractions enriched and depleted of additive. In the theoretical case where the additive and the host catalyst have an identical particle size distribution, one would expect identical formulation as a function of particle size. In this EXAMPLE, the additive has a larger average particle size (76 microns) even though it has 14% 0-40 micron content versus the ECAT (68 microns). This ECAT has a low amount of large particles greater than 107 microns (165 mesh). The data of Table 4 is consistent with a 165+ fraction enriched with additive and a 200-fractions slightly depleted of the additive. The differences are explained by the difference in the starting particle size of the host and the additive. However, the fractions of the additive smaller than 107 microns is somewhat homogenous as measured by the P2O5 level which is a measurement of the amount of additive.

TABLE 5

| | | | Larger | Heart | | |
|---|---|---|---|---|---|---|
| | | CATA- | than | Cut | smaller | CATA- |
| | | LYST | 165+ | 165−/ | than | LYST |
| | | A | mesh | 200+ | 200sh | AA |
| | | 100% | 4% | 6% | 90% | 94% |
| Na (%) | | 0.21 | 0.23 | 0.21 | 0.19 | 0.19 |
| Ni (%) | | 0.09 | 0.07 | 0.06 | 0.08 | 0.08 |
| V (%) | | 0.12 | 0.11 | 0.18 | 0.11 | 0.11 |
| P2O5 (%) | | 1.06 | 3.20 | 1.46 | 0.96 | 1.05 |
| P2O5(5)* | | 0.52 | 2.66 | 0.92 | 0.42 | 0.51 |
| Al2O3 (%) | | 38.34 | 37.34 | 42.40 | 37.39 | 37.39 |
| Fe2O3 (%) | | 0.88 | 0.82 | 0.93 | 0.87 | 0.86 |
| MgO (%) | | 1.81 | 2.14 | 4.25 | 1.60 | 1.63 |
| TiO2 (%) | | 1.53 | 1.38 | 1.58 | 1.51 | 1.51 |
| SiO2 (%) | | 54.48 | 57.73 | 57.09 | 53.63 | 53.80 |
| CeO2 (%) | | 0.26 | 0.28 | 0.52 | 0.23 | 0.24 |
| La2O3 (%) | | 2.03 | 1.41 | 1.70 | 2.06 | 2.03 |
| APS, | % | 68 | 120 | 101 | 64 | |
| microns | | | | | | |

Catalyst BB:

Catalyst B was sieved with the same sieves with which the additive was made in order to show that by having a narrow particle size distribution, a catalyst composite can be separated into its individual components with a high degree of specificity. Table 6 shows the chemical analysis of the different fractions.

The results clearly show that for the catalyst smaller than 200 micron, the separation was almost perfect and there is no P2O5 in excess of what the starting catalyst host had.

For the very small fraction above the 165+ mesh threshold (4% of the total catalyst system), there was a high amount of ZSM-5 additive present because of the lack of host particles in that particle size range.

TABLE 6

| | | | | | | CATA- |
|---|---|---|---|---|---|---|
| | | | Larger | Heart | smaller | LYST |
| | | CATA- | than | Cut | than | BB |
| | | LYST | 165+ | 165−/ | 200 | 165−/ |
| | | B | mesh | 200+ | mesh | 200+ |
| | | 100% | 4% | 5% | 91% | 95% |
| Na (%) | | 0.23 | 0.22 | 0.21 | 0.20 | 0.20 |
| Ni (%) | | 0.08 | 0.05 | 0.05 | 0.09 | 0.08 |
| V (%) | | 0.13 | 0.09 | 0.13 | 0.12 | 0.12 |
| P2O5 (%) | | 1.15 | 4.42 | 3.11 | 0.51 | 0.68 |
| P2O5(5)* | | 0.61 | 3.88 | 2.57 | −0.03 | 0.14 |
| Al2O3 (%) | | 43.25 | 36.28 | 37.87 | 38.69 | 38.59 |
| Fe2O3 (%) | | 0.94 | 0.80 | 0.85 | 0.88 | 0.88 |
| MgO (%) | | 2.18 | 1.69 | 2.74 | 1.78 | 1.77 |
| TiO2 (%) | | 1.69 | 1.31 | 1.39 | 1.56 | 1.55 |
| SiO2 (%) | | 60.92 | 59.08 | 56.31 | 53.98 | 54.20 |
| CeO2 (%) | | 0.30 | 0.23 | 0.35 | 0.26 | 0.26 |
| La2O3 (%) | | 2.23 | 1.26 | 1.43 | 2.16 | 2.12 |
| APS, microns | % | 71 | 115 | 100 | 64 | 66 |

Catalyst CC

Catalyst C was sieved with the same sieves with which the additive was made in order to show that by having a narrow particle size distribution, a catalyst composite can be separated into its individual components with a high degree of specificity. Table 7 shows the chemical analysis of the different fractions.

In this case, the particles larger than the 250 mesh (52%) showed no evidence of any ZSM-5 additive left given the P2O5 level which matches that of the starting catalyst host.

The fines smaller than the 325 mesh still show some additive present due to the very small amount of 325 mesh particles in the FCC catalyst host.

TABLE 7

| | | | | | | CATA- |
|---|---|---|---|---|---|---|
| | | | Larger | Heart | smaller | LYST |
| | | CATA- | than | Cut | than | CC |
| | | LYST | 250+ | 250−/ | 325 | 165−/ |
| | | C | mesh | 325+ | mesh | 200+ |
| | | 100% | 52% | 37% | 11% | 63% |
| Na (%) | | 0.21 | 0.21 | 0.22 | 0.23 | 0.21 |
| Ni (%) | | 0.08 | 0.08 | 0.09 | 0.06 | 0.07 |
| V (%) | | 0.12 | 0.15 | 0.11 | 0.09 | 0.14 |
| P2O5 (%) | | 1.04 | 0.55 | 1.47 | 1.61 | 0.74 |
| P2O5(5)* | | 0.50 | 0.01 | 0.93 | 1.07 | 0.19 |
| Al2O3 (%) | | 38.50 | 41.09 | 38.81 | 36.57 | 40.30 |
| Fe2O3 (%) | | 0.88 | 0.91 | 0.90 | 0.83 | 0.90 |
| MgO (%) | | 1.92 | 2.86 | 1.57 | 1.34 | 2.59 |
| TiO2 (%) | | 1.54 | 1.61 | 1.55 | 1.51 | 1.59 |
| SiO2 (%) | | 54.73 | 55.24 | 56.75 | 55.67 | 55.32 |
| CeO2 (%) | | 0.27 | 0.38 | 0.23 | 0.21 | 0.35 |
| La2O3 (%) | | 2.03 | 1.99 | 2.14 | 2.08 | 2.01 |
| APS, | % | 65 | 87 | 56 | 38 | 78 |
| microns | | | | | | |

Thus, as shown above, this embodiment of the present invention was utilized to create narrow particle size distributions with varying amounts of ZSM-5 (as shown by the quantities of P2O5 in the various blends) and therefore, various levels of efficiency.

### Example of Particle Size of a Population

The nature of spray driers is such that they produce quasi-spheres by creating a distribution of droplets of a slurry mixture (typically with 25-40% solids in it) which then is subjected to hot air to evaporate the liquid media (typically water in FCC catalysts). By the nature of the physical phenomena used to generate the droplets, either centrifugal rotation or a pressured nozzle, the droplets have a particle size distribution that will correlate with the dried product particle size distribution.

In practice, the particles are not 100% spherical due to many reasons which include asymmetries in the drying rates, homogeneity of the slurry, back mixing within the chamber and many other phenomena.

Furthermore, the measurement of a particle size involves typically laser light scattering techniques or screening techniques. Particle size distributions, particle shape deviation from sphericity, and measurement approximation make the definition of size of a spray dried product difficult and in general, a single number is not enough to define it uniquely. For this reason, we introduce the concept of an Asymmetrical Particle Size Distribution function, like the Bragg Equation.

The Bragg equation is one of several mathematical functions that can be used to describe probability distributions that are not symmetrical. For example, the classical Gauss distribution is symmetrical and can be uniquely described once the average and the standard deviation are known; however, the Bragg equation can use 4 parameters for increased flexibility and to shift the peak of the curve left or right as needed to fit different particle size distributions.

The formula for the Bragg equation is:

f(x)=Theta₁+(Theta₂−Theta₁)·exp^{[(-Theta}^{₃}^{·(X-Theta}^{₄}⁾⁾^{²}^{]}
X=particle size

The Bragg equation is one of the many equations suggested by the Minitab Statistical Suite as part of the non-linear regression catalog of functions. This function; however, was chosen because it fits well particle size distributions from typical commercial spray driers. A graphical example of the use of this function for curve fitting was shown in graph #1 below.

It is important to notice that particle size distributions are expected to be continuous, in the mathematical sense and having a single maximum. The presence of multiple maxima (peaks) are typical indications of blends of two different, independently made materials with different starting particle size distribution.

This definition can take into account, in a practical manner, all the approximations that include but are not limited to: non-sphericity of the particles, light scattering data manipulation and sensitivity to different parameters like laser wavelength and others.

By defining a mathematical equation, it is possible to define the homogeneity of a distribution in a practical and unique sense. The area under the curve is representative of the percentage of the population between that range. Typical spray driers produce FCC catalysts and additives in the range from 10 to 250 microns. As shown in the example below, the full range is approximately 200 microns. Because of the low rate of change of the slope above 120 microns, most of the population is within a 120 micron range. We define an state of the art FCC additive as those having a distribution where 80% of the particles full within a range of 100 microns or more.

A way to define some of the improved FCC additive compositions is for any composition with an average particle size distribution, measured with a light scattering apparatus, larger than 20 microns but less than 100 microns where 80% of all the particles fall within a range of less than 60 microns.

We also introduce a useful parameter FWHM which can be an indicator of how homogeneous or tight a particle size distribution is. FWHM (Full Width at Half Maximum) is defined at the range of particles covered at half of the maximum of the distribution. The typical FWHM for a current FCC catalyst or additive is 70 microns

An alternate way to define some of the improved FCC additive compositions is for any composition with an average particle size distribution, measured with a light scattering apparatus, larger than 20 microns but less than 100 microns and a Full Width at Half Maximum of 50 microns.

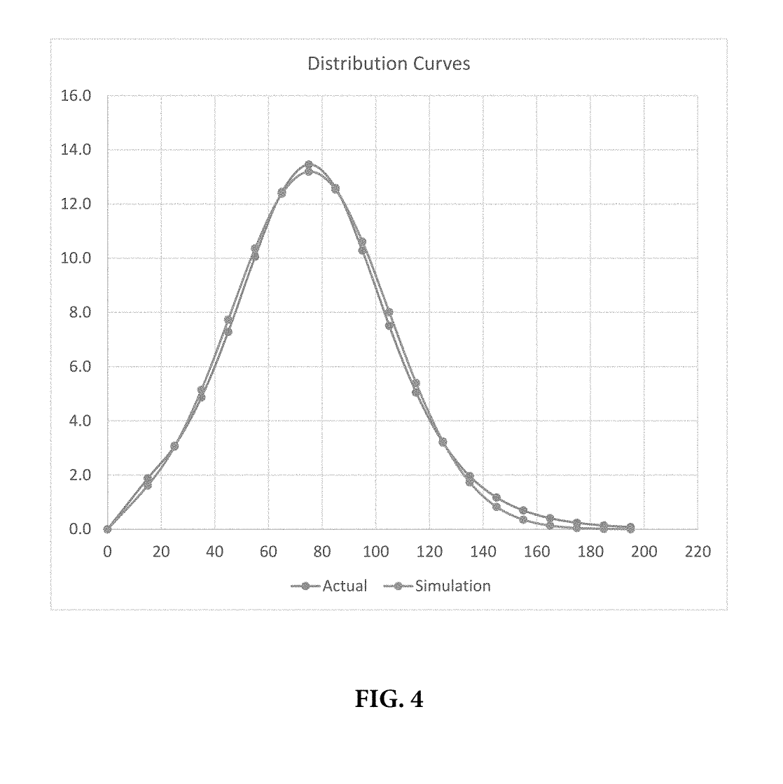

The differentiation of two particle size distribution can be formally defined by deconvolution as the difference between two distributions which do not overlap above half the maximum of the one with the highest peak. Distributions with higher degree of overlap may require a more detailed description but in essence, it is difficult to deconvolute them accurately. FIG. 4 shows a typical particle size distribution.

The following shows the Bragg equation for typical FCC Additives.

f(x)=Theta₁+(Theta₂−Theta₁)−exp^{[(-Theta}^{₃}^{·(X-Theta}^{₄}⁾⁾^{²}^{]}

### Bragg Equation Fit for Typical FCC Additive

| Parameter | Value |
|---|---|
| θ₁ = minimum value of f(x) | 0.000 |
| θ₂ = maximum value of f(x) | 13.196 |
| θ₃ = width parameter | 5.74E−04 |
| θ₄: = value of x for which f(x) is Maximum, | 75.516 |
| similar to the median of x for the distribution | |

### and to the Average Particle Size

### Where Theta1=0

The FWHM is equal to 2*(LN(½)/Theta₃)^{1/2}
FWHM is equal to 69.51 for the distribution above.

1. One or more fractions of an FCCU additive created by removing one or more fractions above a size threshold that is larger than the size at which particle size distribution of the initial additive is maximum.

2. An FCCU additive composition wherein at least one particle over 70 microns has been intentionally removed.

3. One or more narrow fractions of an FCCU additive created by removing at least 80% of the particles below a size threshold and removing at least 80% of the particles above another larger threshold.

4. A method for separation of an additive from an FCCU catalyst mixture comprising:
(a) providing an FCCU catalyst mixture comprising a FCCU catalyst and an additive having different particle size distributions;
(b) creating two or more fractions where at least one of the fractions is depleted of the additive and at least one of the fractions is enriched with the additive relative to original FCCU catalyst mixture

5. A method for separation of an additive from an FCCU catalyst mixture comprising:
(a) providing an FCCU catalyst mixture comprising a FCCU catalyst and an additive having a particle size distribution with a size range of less than 100 microns;
(b) separating the additive having a particle size range of less than 100 microns and the FCCU catalyst.

6. An improved FCCU additive where particles above a size threshold have been removed

7. An FCCU additive with smaller average particle size than typical with an improved catalytic function for which the original additive was designed

8. An improved FCCU additive composition created by removing one or more fractions below the size at which particle size distribution of the initial additive is maximum.

9. A method for creating an improved FCCU additive composition comprising intentional removing at least one particle below or above a threshold.

10. The method of claim 9 wherein the threshold is 50 microns and the particle is below 50 microns.

11. The method of claim 9 wherein the threshold is 70 microns and the particle is above 70 microns.

12. A method for improving an FCCU additive composition comprising dividing the additive into more than one fraction such that each fraction contains a range of particle sizes.

13. The method of claim 12 wherein each fraction contains a range of particle sizes, and including combining more than one, but less than all, of these fractions together.

14. The method of claim 12 wherein fractions with an average particle size below a minimum threshold are reprocessed into larger particles.

15. The method of claim 14 wherein fractions with an average particle size above a maximum threshold are reprocessed into smaller particles.

16. The method as recited in claim 12 wherein fractions with an average particle size below a minimum threshold are reprocessed into larger particles and fractions with an average particle size above a maximum threshold are reprocessed into smaller particles and two or more of the resulting fractions are combined.

17. A method to improve performance of an FCCU comprising:
(a) limiting the particle size distribution of an additive to a desired range; and
(b) introducing the limited particle size distribution additive into the FCCU.

18. The method as recited in claim 17 wherein the improved performance is environmental performance and the additive is for SOx reduction.

19. The method as recited in claim 17 wherein the improved performance is environmental performance and the additive is for NOx reduction.

20. The method as recited in claim 17 wherein the improved performance is the operation of the regenerator of an FCCU and the additive is a CO combustion promoter additive.

21. The method as recited in claim 17 wherein the improved performance is an increase in gasoline octane or an increase light olefin production and the additive is a shape-selective zeolite additive.

22. The method as recited in claim 17 wherein the improved performance is to decrease the effects of contaminant metals on FCCU catalyst activity and selectivity and the additive is a metal passivation additive

23. The method as recited in claim 17 wherein the improved performance is the selective pre-cracking of large feed molecules and the additive is a bottoms-cracking additive.

24. An FCC Additive with a particle size distribution measured by laser light scattering has a maximum at a particle size below 100 microns and where 80% of more of the particles fit within a range of no more than 60 microns.

25. An FCC Additive with a particle size distribution measured by laser light scattering with a maximum at a particle size below 100 microns and a full width at half maximum (FWHM) less than 60 microns.
